(19) United States
(12) Patent Application Publication
(10) Pub. No.: US 2019/0265141 A1
(43) Pub. Date: Aug. 29, 2019

(54) SUSPENSION-BASED IMPACT SYSTEM

(71) Applicant: Simon Fraser University, Burnaby (CA)

(72) Inventors: Daniel Eamon Abram, Vancouver (CA); Farid Golnaraghi, West Vancouver (CA); Gaofeng Gary Wang, Surrey (CA)

(73) Assignee: Simon Fraser University, Burnaby, BC (CA)

(21) Appl. No.: 16/289,140

(22) Filed: Feb. 28, 2019

Related U.S. Application Data
(60) Provisional application No. 62/636,732, filed on Feb. 28, 2018.

(51) Int. Cl. G01N 3/303

(52) U.S. Cl. CPC G01N 3/303; G01N 2203/0617; G01N 2203/0033

(57) ABSTRACT

The present disclosure generally relates to a suspension-based impact test system for testing impact of a testing object against an impacting object. The impact test system includes components to couple the testing object to a suspension arm through a coupling member, and the suspension arm interfaces a motion-guiding mechanism. The impact test system generally includes a detachment mechanism for releasing the testing object from the suspension arm when initiated by a release system. The testing object releases from the constraints such that the testing object can move freely just prior to contacting the impacting object.

### CROSS-REFERENCE TO RELATED APPLICATION

This application claims the benefit of Provisional Application No. 62/636,732, filed Feb. 28, 2018, the entire disclosure of which is hereby incorporated by reference herein.

### BACKGROUND

Impact test systems are generally used for quality control and safety testing in the developing, certificating, and manufacturing of protective equipment and safety products, such as protective headgear, vehicle safety features, protective casing and packaging, and other products. Such test systems can have mechanical or electronic adjustment, allowing the operator to choose different impact speeds for the test. To collect data about the impact, the object being tested is often directly equipped with sensors, coupled to another object equipped with sensors, and/or associated with sensors in the testing area, which measure certain data about the impact.

In various impact test systems, the testing object may fall vertically, swing on a pendulum, or move horizontally or at an angle before making contact with the impacting object, which is generally be a wall, an anvil, a separate testing object, or any other object. The impacting object may be made of any suitable material, with the surface exposed or covered with another material such as fabric, sandpaper, metal, or concrete.

Current impact test systems commonly used for quality control of helmets include a ram pendulum, or have the helmet on a dummy head sitting in a carriage or basket connected to a rail. In impact test systems including a ram pendulum, a helmeted headform is impacted by another object at the end of the ram pendulum: either a hammer-type object or another helmeted headform. The resulting motion of the helmeted headform being tested is constrained by anchoring to a platform. In impact test systems where the helmeted headform is in a basket, the basket drops through the anvil, allowing the helmet to collide with the anvil; however, the basket-based systems have several disadvantages. In a basket-based system, the basket often wears out quickly as a result of a sudden stop below the anvil. In addition, the helmet is likely to impact the basket after impacting the anvil, which can damage the basket and other parts of the test system, including the helmet, the headform, and/or the sensors. The constraint of the testing object in current impact test systems provide results that typically do not correspond to an accurate representation of the movement of a human head during real-world impacts.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an impact test system is provided. The impact test system generally includes a suspension arm couplable to a testing object at a connection point; a motion-guiding mechanism interfacing the suspension arm, the motion-guiding mechanism configured to allow the suspension arm to move from an initial location to an intermediate location along a path; and a detachment mechanism configured to decouple the testing object from the suspension arm to allow unconstrained motion of the testing object prior to contacting an impacting object.

In accordance with any of the embodiments described herein, the impact test system may further comprise a commencement system configured to initiate the motion of the suspension arm and the testing object along the path.

In accordance with any of the embodiments described herein, the commencement system may be selected from the group consisting of mechanical, electronic, pneumatic, hydraulic, motorized, and any combination thereof.

In accordance with any of the embodiments described herein, the impact test system may further comprise a release system associated with the detachment mechanism to initiate the unconstrained motion of the testing object by releasing the testing object from the suspension arm prior to contacting the impacting object.

In accordance with any of the embodiments described herein, the release system may be selected from the group consisting of mechanical, electronic, pneumatic, hydraulic, motorized, and any combination thereof.

In accordance with any of the embodiments described herein, the impact test system may further comprise a coupling member configured to couple the testing object to the suspension arm until the release system releases the testing object.

In accordance with any of the embodiments described herein, the coupling member may comprise one or more of a wire, a rope, and a magnet for temporarily coupling the testing object to the suspension arm.

In accordance with any of the embodiments described herein, the detachment mechanism may form a portion of the suspension arm, and wherein the coupling member may be configured to couple the testing object to the detachment mechanism.

In accordance with any of the embodiments described herein, the impact test system may further comprise a stabilizer configured to maintain the testing object in a desired orientation until the testing object is released from the suspension arm.

In accordance with any of the embodiments described herein, the stabilizer may comprise one or more of a hook and loop material and magnets.

In accordance with any of the embodiments described herein, the motion-guiding mechanism may control movement of the suspension arm by at least one of a mechanical mechanism, an electronic mechanism, a pneumatic mechanism, a hydraulic mechanism, and a motorized mechanism.

In accordance with any of the embodiments described herein, the mechanical mechanisms may be selected from the group consisting of rail, ropes, pulleys, magnets, wire, and combinations thereof.

In accordance with any of the embodiments described herein, the motion-guiding mechanism may control movement of the suspension arm in a vertical, horizontal, angled, or arcuate path.

In accordance with any of the embodiments described herein, the suspension arm and testing object may travel along the path under the influence of gravity.

In accordance with any of the embodiments described herein, the impacting object may comprise a contacting surface disposed normal or oblique to a contacting surface of the testing object.

In accordance with any of the embodiments described herein, the contacting surface of the impacting object may at least partially be covered with a material selected from the group consisting of paper, fabric, sandpaper, concrete, metal, wood, rubber, and any combination thereof to provide a specified surface condition for testing.

In accordance with any of the embodiments described herein, the detachment mechanism may be actuated by at least one of a mechanical actuator, an electronic actuator, a pneumatic actuator, a hydraulic actuator, a motor.

In accordance with any of the embodiments described herein, the testing object may comprise multiple components that are rigidly coupled or move relative to each other.

In accordance with any of the embodiments described herein, one or more of the testing object, the impacting object, and the impact test system may include at least one sensor configured to measure kinetic and kinematic parameters, such as displacement, velocity, acceleration, force, vital signs, other measurements required for impact testing, or any combination thereof.

In accordance with any of the embodiments described herein, the impact test system may be enclosed in an enclosure for increased safety of the operator and surrounding equipment.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIGS. 1A and 1B are environmental views of a representative embodiment of an impact test system in accordance with an aspect of the present disclosure;

FIG. 2 is a detail view of one embodiment of a suspension arm of the impact test system of FIGS. 1A and 1B, showing the suspension arm and adjacent components; and

FIG. 3 is an environmental view of a representative embodiment of a horizontal impact test system in accordance with another aspect of the present disclosure.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “forward,” “rearward,” “front,” “rear,” “upward,” “downward,” “top,” “bottom,” “right hand,” “left hand,” “lateral,” “medial,” “in,” “out,” “extended,” etc. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

The present disclosure is generally related to systems, methods, and apparatuses used for impact testing. Embodiment of the suspension-based impact test system (herein, the “impact test system”) of the present disclosure includes a testing object attached to a suspension arm that undergoes a guided motion in a vertical, angled, horizontal, arcuate, or other suitable path. In some embodiments, the motion is a result of conversion of potential energy into kinetic energy, such as by gravity, elasticity, or other suitable potential energy source. In other embodiments, the motion created by or a motor or other suitable kinetic energy generating source.

In some embodiments, during use, the testing object is released shortly before impact such that the testing object can move freely during and after impact. The testing object contacts the impacting object at any given angle.

The impact test system of the present disclosure may include various advantages over conventional testing systems, including reduced maintenance operation and lower risk of the testing object making unanticipated contact with parts of the test system after colliding with the impacting object. During impacts as part of the testing procedure, a point on the testing object makes contact with the impacting object. In conventional test systems having a basket component, as described above, the impacting object sits on the basket with multiple contact points. In these conventional systems, during oblique impacts when the testing object strikes the impacting object, the testing object may roll on the last departure point, often disrupting the desired dynamics of the impact. In this regard, test measurements are altered, adding inaccuracy to the results of the test.

The impact test system of the present disclosure is generally lighter in weight than conventional impact systems that include a basket. In representative embodiments of the impact test system described herein, the testing object is unconstrained by the components of the test system securing the testing object at the moment just prior to collision with the impacting object, allowing for a more accurate representation and correlation to an in-service impact of the testing object, e.g., a helmet, and allowing impacts to a specific location on the testing object be more reliably tested.

Using embodiments of the present disclosure, particularly during oblique impact tests, free movement of the object during impact generates results with a better correlation to in-service performance than if the testing object is anchored during impact, causing a varying degree of constrained motion. Typical in-service impact scenarios for helmets and other protective equipment last from 5-10 milliseconds (ms), with relatively high acceleration and small displacement. In such instances of an in-service helmet, there is little time for the body to respond and for the muscles in the neck to contract and counter the impact. In this regard, the head of a user more closely correlates to the unconstrained motion of the testing object used in embodiments of the impact test system of the present disclosure.

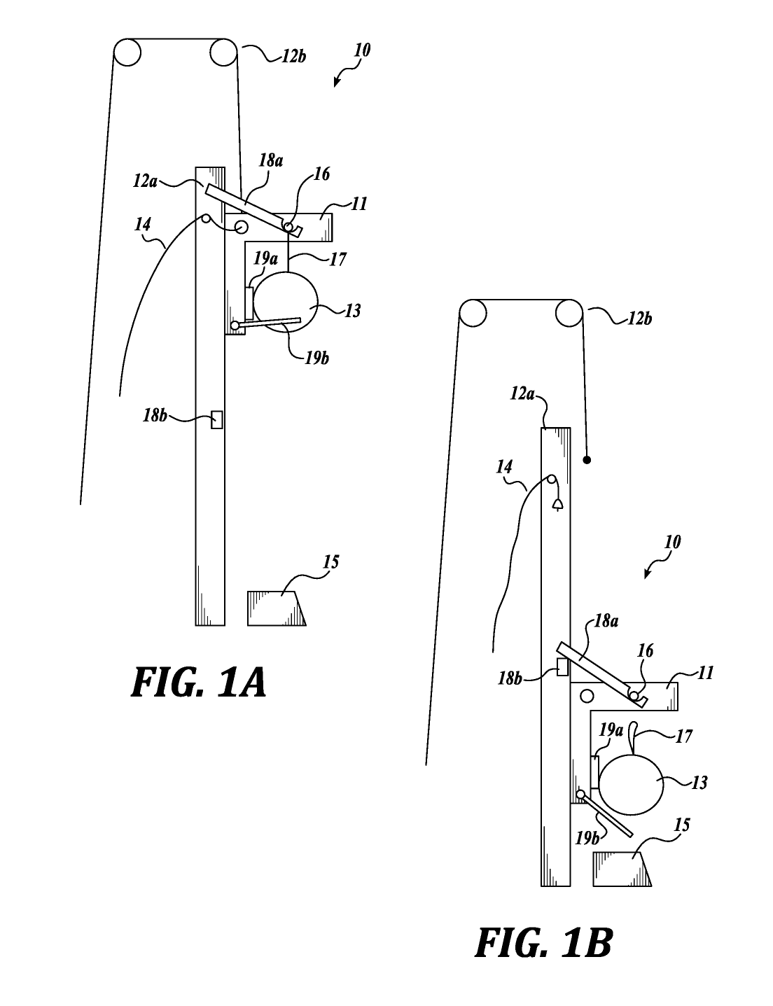

Turning to FIGS. 1A and 1B, one representative embodiment of an impact test system 10 is shown. In the illustrated embodiment, the impact test system 10 generally includes a suspension arm 11 for carrying a testing object 13, a release system (a release arm 18a and a release block 18b), an impacting object 15, a detachment mechanism 16, a coupling member 17, and a commencement system 14. In some embodiments, the impact test system 10 includes a stabilizer 19a and 19b. As shown, the suspension arm 11 is slidingly connected to a motion-guiding mechanism 12a, which guides the path of the suspension arm 11 during the test. In some embodiments, the motion-guiding mechanism 12a allows the movement of the suspension arm 11 in a vertical, horizontal, angled, or curved path, or any combination thereof.

In some embodiments, the suspension arm 11 is connected to a suspension arm holding system 12b, which fixes the suspension arm 11 in place along the motion-guiding mechanism 12a and allows the suspension arm 11 to be moved to a desired location. The coupling between the suspension arm 11 and suspension arm holding system 12b is controlled by the commencement system 14, which allows the suspension arm 11 to be uncoupled from the suspension arm holding system 12b when the commencement system 14 is actuated. The commencement system 14 initiates the guided movement of the suspension arm 11 and attached testing object 13. In some embodiments, the commencement system 14 is actuated manually by a user. In other embodiments, the commencement system 14 is actuated remotely by a signal, such as electronically, electro-mechanically, magnetically, etc. In further embodiments, the commencement system 14 employs any suitable actuation scheme to initiate the release of the suspension arm 11 from the suspension arm holding system 12b.

In some embodiments, as the suspension arm 11 is released from the suspension arm holding system 12b and travels along the motion-guiding mechanism 12a, before impact, the release system, including the release arm 18a and the release block 18b, are used to enable unconstrained motion of the testing object 13. In this regard, the release arm 18a impacts the release block 18b during motion of the suspension arm 11, such that the release arm 18a releases the testing object 13 from the suspension arm 11 prior to making contact with the impacting object 15. Once the release arm 18a releases the testing object 13, contact is made by the testing object 13 with the impacting object 15.

In some embodiments of the release arm and block 18a and 18b, the detachment mechanism 16 is used to release the testing object 13. In these embodiments, the detachment mechanism 16 is located on the suspension arm 11 and holds a coupling member 17, and resultantly holds the testing object 13. The coupling member 17 connects the testing object 13 to the detachment mechanism 16 on the suspension arm 11 until the release arm and block 18a and 18b releases the testing object 13 from the detachment mechanism 16.

In some embodiments, the stabilizer 19a and 19b stabilizes the testing object 13 in the desired orientation at the start of the impact test, before the release arm and block 18a and 18b frees the testing object 13 for unconstrained motion, as will be explained in greater detail below.

A representative test sequence having three steps will now be described in detail. The first step of the representative test sequence occurs when the testing object 13, stabilized by the stabilizer 19a and 19b, is coupled to the suspension arm 11 through the coupling member 17 before guided movement is initiated. The second step of the representative test sequence includes releasing the testing object 13 from the suspension arm 11, by the release arm and block 18a and 18b, to initiate unconstrained motion. The third step of the representative test sequence occurs when the testing object 13 makes contact with the impacting object 15 after being released from the suspension arm 11.

The illustrated embodiment in FIG. 1A shows the impact test system 10 in an initial position, ready for the impact test to begin. The illustrated embodiment in FIG. 1B shows the impact test system 10 in an intermediate position during a representative test sequence, with certain of the components in motion. In this intermediate position, the commencement system 14 has been initiated, decoupling the suspension arm 11 and the suspension arm holding system 12b and causing the suspension arm 11 to travel along the motion-guiding mechanism 12a. As the suspension arm 11 travels along the motion-guiding mechanism 12a, the components of the release system, release arm and block 18a and 18b, engage and cause the detachment mechanism 16 to release the coupling member 17, initiating free motion of the testing object 13 and detachment of the stabilizers 19a and 19b from the testing object 13.

In an embodiment, one or more of the motion-guiding mechanism 12a and the suspension arm holding system 12b are mechanical mechanisms. In this embodiment, the mechanical mechanisms are selected from the group consisting of rail, ropes, pulleys, magnets, wire, and any combination thereof.

In some embodiments, the stabilizers 19a and 19b comprise a hook and loop material, magnets, clamps, rods, any combination thereof, or other suitable methods for stabilizing. In one embodiment, stabilizer 19a comprises hook and loop coupling and stabilizer 19b comprises of rods. In these embodiments, the stabilizer 19a temporary couples to and stabilize the testing object 13 in the desired orientation and decouples from the testing object 13 when the release arm and block 18a and 18b are initiated. The stabilizer 19b holds and stabilizes the testing object 13 in the desired orientation and swings outwards to release its hold on the testing object 13 when the release system is initiated.

In some embodiments, the impact test system 10 may include a braking system (not shown) configured to stop the suspension arm 11 at a desired point along a path of travel. The braking system can use any of the conventional braking mechanism for a moving object such as cushions, mechanical brakes, stopping wires, magnetic brakes or any combination thereof. Although the illustrated embodiments may include a singular representation of a component, any number of components, such as a plurality of coupling members 17 and/or the stabilizers 19a and 19b, is also within the scope of the present disclosure.

In some embodiments, the impact test system 10 is mechanical, such that certain of the steps for using the impact test system 10 must be manually performed by an operator. In other embodiments, any number of the components may be automated. As non-limiting examples, the commencement system 14, release system, detachment mechanism 16, and/or suspension arm holding system 12b may be mechanical, electronic, pneumatic, hydraulic, motorized, or any combination thereof.

In one embodiment, at least one of the testing object 13 and the impact test system 10 are equipped with sensors (not shown) configured to measure kinetic and kinematic parameters, such as displacement, velocity, acceleration, force, vital signs, other measurements required for impact testing, or any combination thereof. The sensors may include provisions for communication with computers or other machines outside of the impact test system area, such as wired, wireless, BLUETOOTH®, Near-Field Communication (NFC), etc. In some embodiments, the impact test system 10 may be enclosed in an enclosure, such as a case or cage, for increased safety of the operator and surrounding equipment.

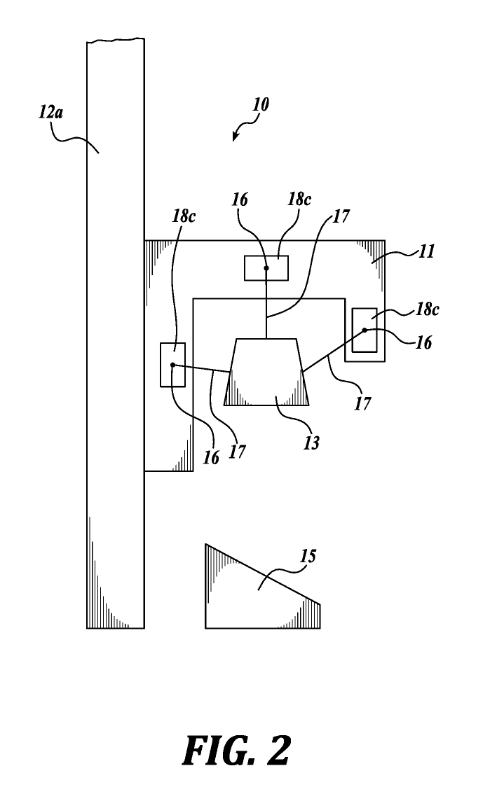

Turning to the detail view in FIG. 2, an embodiment of the suspension arm 11 and adjacent components of an impact test system 10 is shown. As illustrated, the suspension arm 11 is in an intermediate position during a representative test sequence, with components of the test system 10 in motion. For simplicity, FIG. 2 omits certain components of the impact test system 10. In the illustrated embodiment, an electronic release system 18c is shown, and both the release system 18c and the detachment mechanism 16 are integrated into the suspension arm 11. In other embodiments, the release system is mechanical, such as the release system having the release arm and block 18a and 18b, as shown in FIGS. 1A and 1B.

In FIG. 2, the motion-guiding mechanism 12a is holding the suspension arm 11 in the lowest position, just as the release system 18c is releasing the coupling members 17 from the detachment mechanisms 16, which release the testing object 13 to move without constraint shortly before making contact with the impacting object 15. In these embodiments, a plurality of coupling members 17 stabilizes the testing object 13 in the desired orientation at the start of the impact test. In some embodiments, the coupling members 17 comprises a wire, rope, rigid attachments, magnets, or other suitable methods for temporarily coupling the testing object 13 to the suspension arm 11. In other embodiments, the coupling members 17 detach from the testing object 13.

In these embodiments, a contacting surface of the impacting object 15 can be disposed at any angle relative to a contacting surface of the testing object 13. In other embodiments, the contacting surface of the impacting object 15 and the contacting surface of the testing object 13 have any suitable shape and contour. In other embodiments, the contacting surface of the impacting object 15 is at least partially covered with a material, such as paper, fabric, sandpaper, concrete, metal, wood, rubber, or any suitable material to provide a specified surface condition for testing.

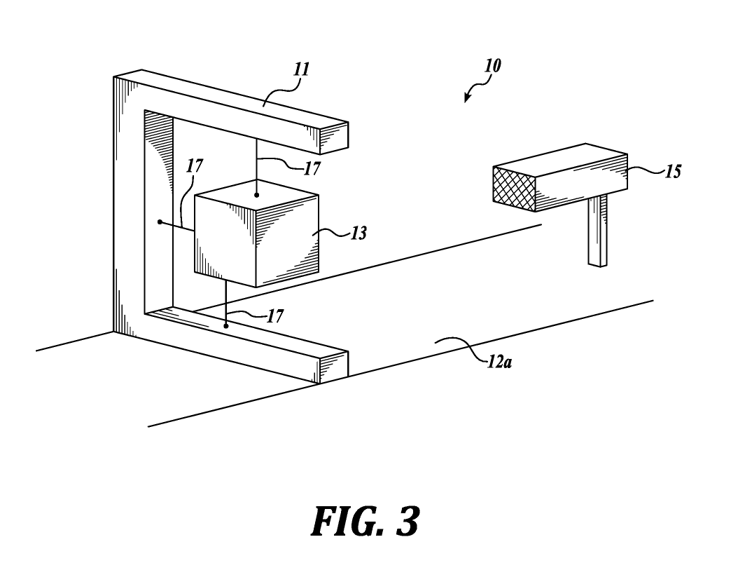

In embodiments of the impact test system 10, the components of the impact test system 10, including the motion-guiding mechanism 12a, are suitably positioned in any orientation, including horizontal, vertical, curved, or at any suitable angle. FIG. 3 shows a representative embodiment of an impact test system 10 orientated horizontally, such that the suspension arm 11 and attached testing object 13 travel along the motion-guiding mechanism 12a towards the stationary impacting object 15. For simplicity, FIG. 3 omits certain components of the impact test system 10.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. An impact test system, comprising:
a suspension arm couplable to a testing object at a connection point;
a motion-guiding mechanism interfacing the suspension arm, the motion-guiding mechanism configured to allow the suspension arm to move from an initial location to an intermediate location along a path; and
a detachment mechanism configured to decouple the testing object from the suspension arm to allow unconstrained motion of the testing object prior to contacting an impacting object.

2. The impact test system of claim 1, further comprising a commencement system configured to initiate the motion of the suspension arm and the testing object along the path.

3. The impact test system of claim 2, wherein the commencement system is selected from the group consisting of mechanical, electronic, pneumatic, hydraulic, motorized, and any combination thereof.

4. The impact test system of claim 1, further comprising a release system associated with the detachment mechanism to initiate the unconstrained motion of the testing object by releasing the testing object from the suspension arm prior to contacting the impacting object.

5. The impact test system of claim 3, wherein the release system is selected from the group consisting of mechanical, electronic, pneumatic, hydraulic, motorized, and any combination thereof.

6. The impact test system of claim 3, further comprising a coupling member configured to couple the testing object to the suspension arm until the release system releases the testing object.

7. The impact test system of claim 6, wherein the coupling member comprises one or more of a wire, a rope, and a magnet for temporarily coupling the testing object to the suspension arm.

8. The impact test system of claim 1, wherein the detachment mechanism forms a portion of the suspension arm, and wherein the coupling member is configured to couple the testing object to the detachment mechanism.

9. The impact test system of claim 1, further comprising a stabilizer configured to maintain the testing object in a desired orientation until the testing object is released from the suspension arm.

10. The impact test system of claim 9, wherein the stabilizer comprises one or more of a hook and loop material and magnets.

11. The impact test system of claim 1, wherein the motion-guiding mechanism controls movement of the suspension arm by at least one of a mechanical mechanism, an electronic mechanism, a pneumatic mechanism, a hydraulic mechanism, and a motorized mechanism.

12. The impact test system of claim 11, wherein the mechanical mechanisms are selected from the group consisting of rail, ropes, pulleys, magnets, wire, and combinations thereof.

13. The impact test system of claim 11, wherein the motion-guiding mechanism controls movement of the suspension arm in a vertical, horizontal, angled, or arcuate path.

14. The impact test system of claim 1, wherein the suspension arm and testing object travel along the path under the influence of gravity.

15. The impact test system of claim 1, wherein the impacting object comprises a contacting surface disposed normal or oblique to a contacting surface of the testing object.

16. The impact test system of claim 15, wherein the contacting surface of the impacting object is at least partially covered with a material selected from the group consisting of paper, fabric, sandpaper, concrete, metal, wood, rubber, and any combination thereof to provide a specified surface condition for testing.

17. The impact test system of claim 1, wherein the detachment mechanism is actuated by at least one of a mechanical actuator, an electronic actuator, a pneumatic actuator, a hydraulic actuator, a motor.

18. The impact test system of claim 1, wherein the testing object is comprised of multiple components that are rigidly coupled or move relative to each other.

19. The impact test system of claim 1, wherein one or more of the testing object, the impacting object, and the impact test system includes at least one sensor configured to measure kinetic and kinematic parameters, such as displacement, velocity, acceleration, force, vital signs, other measurements required for impact testing, or any combination thereof.

20. The impact test system of claim 1, wherein the impact test system is enclosed in an enclosure for increased safety of the operator and surrounding equipment.
